(19) United States
(12) Patent Application Publication
(10) Pub. No.: US 2011/0108407 A1
(43) Pub. Date: May 12, 2011

(54) Desalination Method and Apparatus

(76) Inventor: W. Paul Jepson, Orlando, FL (US)

(21) Appl. No.: 12/989,644

(22) PCT Filed: Apr. 27, 2009
(86) PCT No.: PCT/US09/41763

§ 371 Date: Nov. 24, 2010

Related U.S. Application Data
(60) Provisional application No. 61/125,514, filed on Apr. 25, 2008.

(51) Int. Cl. C02F 1/06; B01D 3/06

(52) U.S. Cl. 203/11; 202/179

(57) ABSTRACT

An improved method and apparatus for the desalination of water, and particularly sea water. The apparatus includes a pump such as a progressive cavity pump driven by a motor, an initial gas/liquid separator such as a gravity separator, a liquid entrainment section such as a serpentine coil, a final in-line gas/liquid separator to separate the moisture-laden air stream from the brine, and a condenser to condense the moisture in the air stream to produce clean water.

### BACKGROUND OF THE INVENTION

1. Technical Field

The present invention relates generally to water treatment methods and associated apparatus, and more specifically to an improved method and apparatus for the desalination of water, and particularly sea water.

2. Background Art

Many areas in the world are adversely impacted by shortages of water, and other areas will be affected in the coming years. Therefore more efficient water treatment and desalination methods are becoming increasingly important. The most commonly used water desalination methods include reverse osmosis, distillation, electrodyalisis, and partial freezing. However, these methods suffer from low efficiency and high energy consumption, thus making their clean water production significantly more expensive than naturally obtained fresh water.

Other proposed water desalination methods include:

U.S. Pat. No. 6,962,053 to Gebel, et al. discloses a wind power plant comprising a seawater desalination system, including a wind power plant with a tower, a gondola carried by the latter so as to rotate about an axis and a rotor mounted in the gondola, the lower containing an evaporator and a vapor compressor mechanically driven by the rotor by a gear.

U.S. Pat. No. 7,052,582 to Madkour describes a wave powered evaporation desalination system for removing fresh water from salt water by extraction of water vapor from a negative pressure container using wave motion for power. The wave powered evaporation desalination system includes a first vessel that accepts salt water. The salt water is forced from the first vessel through a atomizing spray nozzle into the top of a negative pressure second vessel. The negative pressure second vessel includes a number of trays that fill up with salt water films. Two pumps are attached to the top of the second vessel. One pump draws brine from the bottom of the second vessel for dispersion outside the system. The other pump draws off the water vapor from the second vessel into a hose and back to normal atmospheric pressure. The two pumps are powered by a float hinged to the second vessel.

U.S. Pat. No. 7,067,044 to Coon teaches a multi-unit, distributive, regenerable, in situ desalination method. Cultivated field water is desalinated by a series of independent units that float on the water surface, taking up the saline water with a wick, evaporating the water from the wick in desalinating relation by concentrating incident solar radiation with a combination of a lenses and cooperating mirrors onto the upper end portion of the wick while the wick lower end portion is immersed in the field water, capturing the desalinated vapor resulting by condensing within the unit and returning the condensed, desalinated water to the field, and periodically renewing the wick by rinsing the salt from it at a cleaning station beyond the field.

U.S. pat. No. 7,081,205 to Gordon, et al. discloses mobile desalination plants and systems, and methods for producing desalinated water. A vessel includes a water intake system, a reverse osmosis system, a concentrate discharge system, a permeate transfer system, a power source, and a control system. The concentrate discharge system includes a plurality of concentrate discharge ports.

U.S. Pat. No. 7,160,469 to Mayer, et al. describes a system and method for desalination of water, based on borderline fast fluctuation between liquid to gaseous state and back, by using centrifugal forces to make water droplets fly at a high speed, so that they evaporate for a split second, the salt is separated, and they condense again. That invention tries to make the process energy-efficient by enabling the use of lower speeds and smaller droplet sizes.

U.S. Pat. No. 7,309,440 to Borseth teaches a method for desalination of seawater and separation of CO2 from exhaust from a gas turbine. LNG is fed into a heat exchanger in which it receives heat from seawater and heat from steam from an exhaust boiler, and heat from combustion air via a line to an air inlet of the gas turbine, for evaporating LNG to gas which is fed to a gas export module and to a fuel gas skid for supplying the gas turbine with fuel. The combustion air at the air inlet to the gas turbine obtains a lowered temperature and increases the efficiency of the gas turbine. the CO2-rich exhaust gas from the gas turbine is fed into a process unit having an inlet with a fan and an outlet for CO2-reduced exhaust. The cooled seawater from the heat exchanger is fed into the process unit via a coaxial feed pipe for sweater and NH4OH arranged in the process unit. NH4OH is fed into the coaxial feed pipe and is then mixed with the cooled seawater and released via a series of nozzles in several vertical levels from the feed pipe to the process unit's upwards flowing, rotating exhaust. By this device a mixture of NH4OH-containing salt water and CO2-rich exhaust is achieved, for formation of NaHCO3, NH4Cl, and fresh water.

The foregoing patents reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### DISCLOSURE OF INVENTION

The present invention provides an improved method and apparatus for the desalination of water, and particularly sea water. In a first preferred embodiment, the inventive apparatus includes a pump such as a progressive cavity pump driven by a motor, an initial gas/liquid separator such as a gravity separator, a liquid entrainment section such as a serpentine coil, a final in-line gas/liquid separator to separate the moisture-laden air stream from the brine, and a condenser to condensate the moisture in the air stream to produce clean water. The inventive method includes introducing air and a liquid (such as a portion (e.g., 20-50%) of the water to be treated, other water, or other lubricating liquid) into the progressive cavity pump, where the air and liquid are subject to high temperature and pressure (e.g., 300 degrees F. and 300 psig), and then delivered to the initial gas/liquid separator to separate the hot air from the hot liquid. The hot compressed air portion from this initial gas/liquid separator is then expanded through a nozzle or turbine to atmospheric pressure. This has the effect of increasing volume and hence velocity. The water to be treated is injected in this high velocity hot air stream in the serpentine coil section downstream from the nozzle, where the water is combined in the stream. The hot liquid portion from the initial gas/liquid separator passes through a valve to a zone at or near atmospheric pressure, thereby achieving flash evaporation of the hot, high pressure liquid to produce hot water and hot steam. This hot water/steam if then reintroduced into the hot air stream in the coil, to further enhance entrainment of the water into the air. This recombined stream is then delivered to an in-line gas/liquid separator, where the moisture-laden air stream is separated from the brine, and the brine is disposed or otherwise diverted. The moisture-laden air stream is delivered to the condenser where the moisture is condensed to produce clean water.

An alternate embodiment of the inventive desalination method increases system efficiency by providing preheated water through either or both condenser heat of vaporization and compressor preheat.

It is therefore an object of the present invention to provide a new and improved method for desalination of water, and particularly seawater.

It is another object of the present invention to provide a new and improved method for desalination of water that eliminates the need for reverse osmosis, distillation, electrodyalisis, or partial freezing.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty which characterize the invention are pointed out with particularity in the claims annexed to and forming part of this disclosure. The invention resides not in any one of these features taken along, but rather in the particular combination of all of its structures for the functions specified.

There has thus been broadly outlined the more important features of the invention in order that the detailed description thereof that follows may be better understood, and in order that the present contribution of the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the international, regional and national patent office(s) and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designate parts thereof. References in the singular tense include the plural, and vice versa, unless otherwise noted.

### BRIEF DESCRIPTION FO THE DRAWINGS

The invention will be better understood and objects other than those set forth above will become apparent when consideration is given to the following detailed description thereof. Such description makes reference to the annexed drawings wherein:

FIG. 1 is a schematic view of a first preferred embodiment of a desalination apparatus of this invention; and

FIG. 2 is a schematic view of an alternate embodiment of a desalination apparatus with compressor preheat and use of condenser het of vaporization.

### BEST MODE FOR CARRYING OUT THE INVENTION

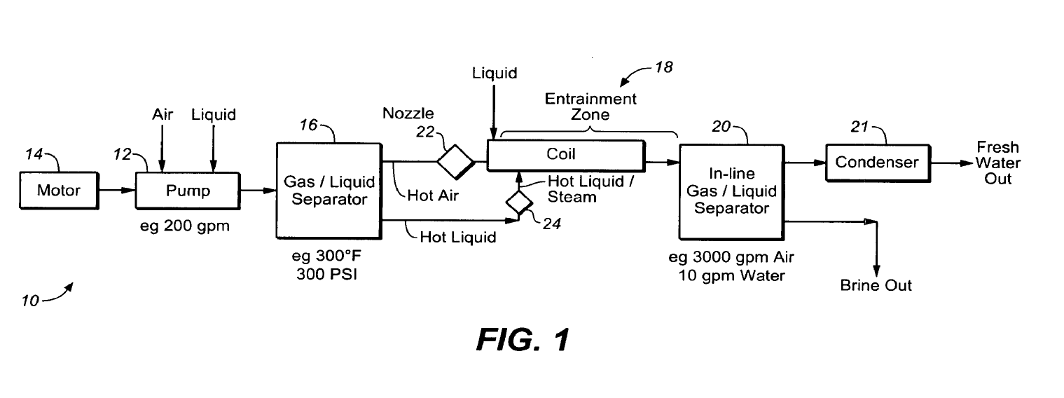

FIG. 1 is a schematic view of a preferred embodiment of a desalination apparatus of this invention. The apparatus 10 includes a pump such as a progressive cavity pump 12 for other pump achieving the desired hot, pressurized gas/liquid output) driven by a motor 14, an initial gas/liquid separator such as a tank or gravity separator 16, a liquid entrainment section such as a serpentine coil 18, a final in-line gas/liquid separator 20 to separate the moisture-laden air stream from the brine, and a condenser 21 to condense the moisture in the air stream into clean water. The inventive method includes introducing air and a liquid (such as a portion (e.g., 20-50%) of the water to be treated, other water, or other lubricating liquid) into the progressive cavity pump 12 (e.g., at 200 gpm), where the air and liquid are subject to high temperature and pressure (e.g., 300 degrees F. and 300 psig), and then delivered to the initial gas/liquid separator 16 to separate the hot air from the hot liquid. The hot compressed air portion from this initial gas/liquid separator is then expanded through a nozzle or turbine 22 to atmospheric pressure. This has the effect of increasing volume and hence velocity. The water to be treated (or, the remainder of the water to be treated, if a portion had been previously input into the pump as described supra) is injected into this high velocity hot air stream in the serpentine coil section 18 downstream from the nozzle 22, where the water is combined in the stream. The hot liquid portion from the initial gas/liquid separator 16 passes through a valve 24 to a zone at or near atmospheric pressure, thereby achieving flash evaporation of the hot, high pressure liquid to produce hot water and hot steam. This hot water/steam is then reintroduced into the hot air stream in the coil 18, to further enhance entrainment of water into the air. The overall length of the coil section 18 is preferably on the order of 200-300 pipe diameters (e.g., twenty feet) to achieve complete entrainment of the water into the air. This recombined stream is then delivered to the in-line gas/liquid separator 20 (e.g., at the rate of 3000 gpm air, 10 gpm water), where the moisture-laden air stream is separated from the brine, then to the condenser 21 where clean water is condensed from the air stream. The brine can be diverted for further treatment, or disposed of.

The high pressure/high temperature gas delivered through the entrainment zone (coil) 18 is able to carry up to ten times or more water than does ambient air. This entrained water, now in the air stream, goes through the separator and condenser to produce the desired clean water.

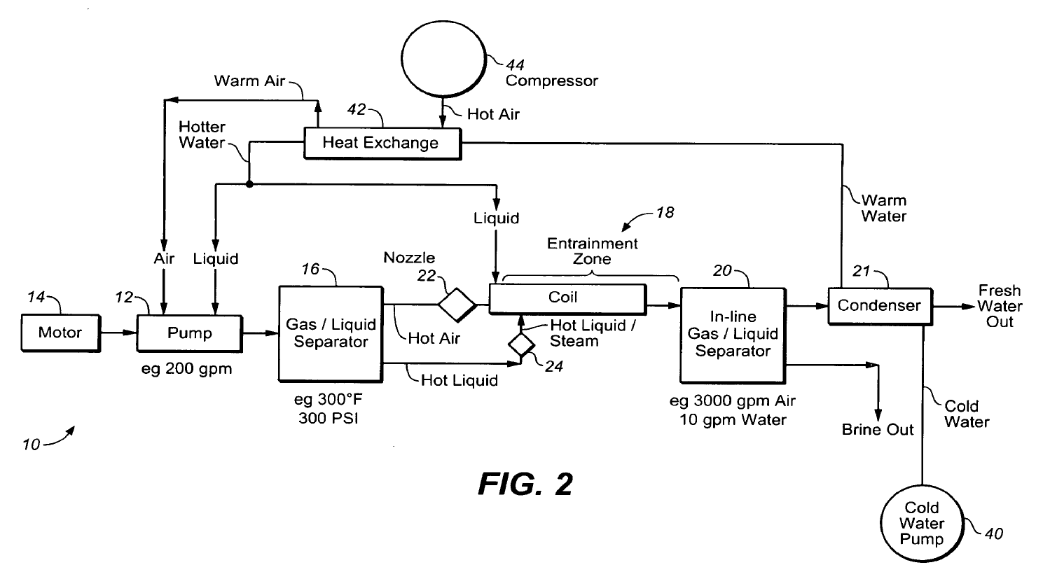

FIG. 2 is a schematic view of an alternate embodiment of a desalination apparatus with compressor preheat and use of condenser heat of vaporization. The flow scheme is essentially the same as that for the embodiment of FIG. 1, but here a cold water pump 40 delivers cold water (e.g., all or a portion of the water to be treated) to condenser 21, where it is initially warmed in the process of condensing the moisture-laden air stream as discussed supra. This warmed water could then be delivered directly to either or both of the liquid input of the pump 12, and/or the liquid input of the coil 18, thereby improving system efficiency by providing preheated water at those steps of the flow scheme. However, in the preferred embodiment, the warmed water that is output from the condenser is first further heated by delivery to heat exchanger 42, which is provided with preheated hot air (e.g., 400 degrees F.) from a blower or compressor 44. Heat exchanger 42 then outputs both preheated warm air (e.g., 150 degrees F.) to the pump 12, and further heated (i.e., hotter) water to the liquid inputs of either or both of the pump 12 and coil 18, thereby further enhancing the efficiency of the system. Alternatively, the heat exchanger 42 could be directly provided with cold water (rather than via the condenser), and heat it and deliver it to the pump and/or coil as described.

The foregoing disclosure is sufficient to enable one having skill in the art to practice the invention without undue experimentation, and provides the best mode of practicing the invention presently contemplated by the inventor. While there is provided herein a full and complete disclosure of the preferred embodiments of this invention, it is not intended to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Accordingly, the proper scope of the present invention should be determined only by the broadest interpretation of the appended claims so as to encompass all such modifications as well as all relationships equivalent to those illustrated in the drawings and described in the specification.

What is claimed as invention is:

1. A desalination apparatus comprising:
a pump;
a first gas/liquid separator connected to said pump;
a liquid entrainment section connected to said first gas/liquid separator;
a second gas/liquid separator connected to said liquid entrainment section; and
a condenser connected to said second gas/liquid separator, wherein air and a liquid are heated and pressurized in said pump, and delivered to said first gas/liquid separator to separate the hot air from the hot liquid; the hot air is expanded through a nozzle to generate a high velocity air stream delivered to said liquid entrainment section; the water to be treated is injected into the air stream in said liquid entrainment section; the hot liquid from said first gas/liquid separator passes through a valve to achieve flash evaporation and produce hot water and hot steam which is reintroduced into the hot air stream in said liquid entrainment section; the combined stream from said liquid entrainment section is delivered to said second gas/liquid separator to separate the moisture-laden air stream from the brine; and the moisture-laden air stream is delivered to said condenser where the moisture is condensed to produce clean water.

2. The desalination apparatus of claim 1 wherein said pump comprises a progressive cavity pump.

3. The desalination apparatus of claim 1 wherein said first gas/liquid separator comprises a gravity separator.

4. The desalination apparatus of claim 1 wherein said liquid entrainment section comprises a coil.

5. The desalination apparatus of claim 4 wherein said coil has a length of 200-300 pipe diameters to achieve complete entrainment of the water into the air.

6. The desalination apparatus of claim 1 wherein said second gas/liquid separator comprises an in-line separator.

7. The desalination apparatus of claim 1 wherein the liquid heated in said pump comprises a portion of the water to be treated.

8. The desalination apparatus of claim 1 further including a cold water pump to deliver cold water to said condenser.

9. The desalination apparatus of claim 1 further including a heat exchanger to provide heated water to said pump.

10. The desalination apparatus of claim 1 further including a heat exchanger to provide heated water to said coil.

11. The destination apparatus of claim 1 further including a heat exchanger to provide healed air to said pump.

12. The desalination apparatus of claim 1 further including a cold water pump to deliver cold wafer to said condenser, and a heat exchanger to draw warm water from said condenser and to provide heated water to said pump and said coil.

13. The desalination apparatus of claim 12 further including a compressor to deliver hot air to said heat exchanger.

14. A method for desalinating water, said method comprising the steps of:
introducing air and a liquid into a pump, and subjecting the air and liquid to high heat and pressure;
delivering the heated and pressurized air and liquid to a first gas/liquid separator to separate the hot water from the hot liquid;
passing the hot compressed air from the first gas/liquid separator over a nozzle to accelerate the air as it expands;
injecting the water to be treated into the high velocity hot air stream in a coil section downstream from the nozzle to entrain the water into the stream;
passing the hot liquid portion from the first gas/liquid separator through a valve to achieve flash evaporation and produce hot water and hot steam;
reintroducing this hot water/steam into the hot air stream in the coil, to further enhance entrainment of water into the air;
delivering the recombined stream to a second gas/liquid separator to separate the moisture-laden air stream from the brine;
diverting the brine; and
delivering the moisture-laden air stream to a condenser where the moisture is condensed to produce clean water.

15. The method for desalinating water of claim 14 wherein said step of introducing air and a liquid into a pump comprises introducing air and a portion of the water to be treated into a progressive cavity pump.

16. The method for desalinating water of claim 14 wherein said step of introducing air and a liquid into a pump comprises introducing warm air and a heated liquid from a heat exchanger into the pump.

17. The method for desalinating water of claim 14 wherein said step of injecting the water to be treated into the high velocity hot air stream comprises injecting heated water from a heat exchanger into the high velocity hot air stream.

18. The method for desalinating water of claim 14 wherein said step of introducing air and a liquid into a pump comprises delivering hot air to a heat exchanger, and introducing warm air and a heated liquid from the heat exchanger into the pump.

19. The method for desalinating water of claim 14 wherein said step of delivering the moisture-laden air stream to a condenser where the moisture is condensed to produce clean water comprises providing cold eater to the condenser from a cold water pump.

20. The method for desalinating water of claim 19 wherein said step of introducing air and a liquid into a pump comprises delivering warm water from the condenser to a heat exchanger, and introducing warm air and a heated liquid from the heat exchanger into the pump.
